(19) United States
(12) Patent Application Publication
(10) Pub. No.: US 2017/0039790 A1
(43) Pub. Date: Feb. 9, 2017

(54) DEVICES AND SYSTEMS FOR ACCESS CONTROL

(71) Applicant: Honeywell International Inc., Morristown, NJ (US)

(72) Inventor: Sanjay Roy, Plymouth, MN (US)

(21) Appl. No.: 14/819,084

(22) Filed: Aug. 5, 2015

(51) Int. Cl. G07C 9/00; H04W 4/00

(52) U.S. Cl. CPC G07C 9/00119; H04W 4/008

(57) ABSTRACT

Devices and systems for access control are described herein. One device includes a wireless receiver component configured to be connected to an access reader, and an input/output (I/O) component configured to be connected to the wireless receiver component and a controller, wherein the wireless receiver component is detachable from the I/O component.

### TECHNICAL FIELD

The present disclosure relates to devices and systems for access control.

### BACKGROUND

Access control systems are designed to provide access to areas of a building for individuals who are authorized to access such areas, and deny access to those areas of the building to individuals who are not authorized to access such areas. For example, certain individuals may be authorized to access a secure area of a building, whereas other individuals may not be allowed to access the secure area.

Access control systems may be difficult to retrofit and/or upgrade. Proprietary controllers and non-interoperable hardware combined with extensive wiring may make the installation of new and/or improved access control devices prohibitively challenging and/or expensive. Under previous approaches, limited space at building doors and at closets housing the controller may necessitate the removal (or relocation) of existing devices to install new devices, further increasing costs.

### BRIEF DESCRIPTION OF THE DRAWINGS

FIG. 1 illustrates an example of a previous system for access control.

FIG. 2 illustrates a device for access control in accordance with one or more embodiments of the present disclosure.

FIG. 3 illustrates a system for access control in accordance with one or more embodiments of the present disclosure.

### DETAILED DESCRIPTION

Devices and systems for access control are described herein. For example, one or more embodiments include a wireless receiver component configured to be connected to an access reader, and an input/output (I/O) component configured to be connected to the wireless receiver component and a controller, wherein the wireless receiver component is detachable from the I/O component.

Embodiments of the present disclosure can enable streamlined user interaction with an existing (e.g., previously installed and operational) access control system through hardware modifications that allow a user's mobile device to function as an access card. Embodiments of the present disclosure can allow flexible retrofits and/or upgrades to existing physical access control systems. Because embodiments of the present disclosure take advantage of existing access control devices and/or infrastructure, they can be installed in a building with minimal disruption and with minimal complication. It is noted that while installation into existing access control systems is discussed herein, embodiments of the present disclosure are not so limited; the device(s) and system(s) in accordance with the present disclosure can be a portion of a new installation.

In an example existing access control system, an access reader (referred to herein as a “reader”) may be located at or near a door of a building. The door may separate a secured area (e.g., room, wing, floor, etc.) of the building from an unsecured area of the building. It is noted that while the term “door” is used herein, embodiments of the present disclosure are not limited to a particular device or structure. That is, “door,” as used herein, can refer to any apparatus that separates one area of a building from another, and/or an entrance to an area to which access may be controlled.

The reader may be a card reader, for instance, to which a user may present a card (e.g., badge and/or other token). The reader may read the card, and then transmit a signal (e.g., request) via one or more wires (and/or via a wireless connection) to an access controller (referred to herein as “controller”). The controller may receive the signal and then make an access determination (e.g., whether the user is allowed access). If the user is allowed access, the controller may send a signal to a relay (or other device) that can provide the user access (e.g., unlock and/or open the door).

Embodiments of the present disclosure can include a modular device having two parts: a wireless receiver component (occasionally referred to herein as a “receiver”) and an input/output (I/O) component.

In some embodiments, the two components can be physically attached (and electrically connected) to each other. That is, one of the components can plug directly into the other component. In some embodiments, the two components can be physically separated from one another while being electrically connected.

According to one or more embodiments of the present disclosure, the receiver and the I/O component, whether separated or attached, can be inserted (e.g., wired) between the reader and the controller in existing access control systems. In some embodiments, an existing wire connecting the reader to the controller can be cut and the receiver and I/O component can each be attached to a respective portion of the cut wire.

The receiver can be located (e.g., installed) near the door such that it can communicate wirelessly with a mobile device carried by a user, for instance. The mobile device, for example, can be a phone (e.g., smartphone), personal digital assistant (PDA), tablet, and/or wearable device (e.g., wristband, watch, necklace, etc.). The receiver can receive a request for access to the secured area from the mobile device, then the request can be relayed the through the I/O component to the controller for making the access determination. In some embodiments, the request for access can include a Wiegand number, for instance.

In some embodiments, the I/O component can be installed near the door along with the receiver. In some embodiments, the I/O component can be physically separated from the receiver (e.g., in different areas of the building). For instance, the I/O component can be installed adjacent to the controller (in a room or closet housing the controller) such that installation requires no damage be done to the building (e.g., walls of the building).

By using a mobile device—something most users typically already carry—embodiments of the present disclosure can streamline user interaction with the access controls system and remove the need for users to carry physical cards. Additionally, because of the variety of identity verification features available on mobile devices, for instance, embodiments of the present disclosure can provide more heightened security than existing card readers. In some embodiments, biometric validation (e.g., fingerprint scanning) can be carried out via the mobile device. Additionally, embodiments herein do not affect the operation of an existing installed reader and thus users can continue using an existing reader even after installation of one or more embodiments of the present disclosure.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. As used herein, “a” or “a number of” something can refer to one or more such things. For example, “a number of ports” can refer to one or more ports.

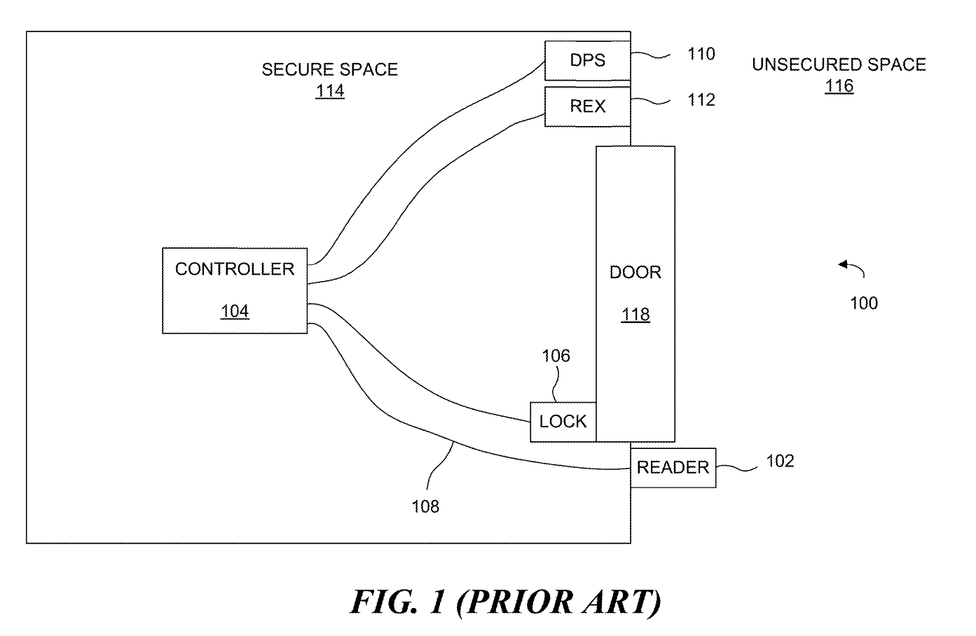

FIG. 1 illustrates an example of a previous system 100 for access control. As shown in FIG. 1, the system 100 can be implemented to control access to a secure space 114 (e.g., a room, a wing, an area, etc.) that is separated from an unsecured space 116 (e.g., another room, wing, area, etc.) by a door 118. A reader 102 can be located at or near the door 118 (e.g., within arm's reach of the door 118).

The reader 102 can read a card presented thereto, and transmit a signal via a wire 108 (e.g., a Wiegand wire) to a controller 104. Though wires, including wire 108, are illustrated herein as a single wire, wires in accordance with embodiments of the present disclosure may contain a plurality of wires (e.g., cores). For instance, a Wiegand wire may include five wires. The controller 104 may receive the signal and then make an access determination. If the user is allowed access, the controller 104 may send a signal to a relay 106 (e.g., electronic door lock) that can provide the user access (e.g., unlock and/or open the door 118).

The system 100 can include one or more sensors. For example, the system 100 can include a door position sensor (DPS) 110 and/or a request to exit (REX) sensor 112. The door position sensor 110 can determine a position of the door 118 (e.g., open or closed). The position of the door 118 can be communicated to the controller 104 via a wired and/or wireless connection between the door position sensor 110 and the controller 104.

The REX sensor 112 can be a device (or devices) configured to provide input(s) upon which the controller 104 can base (e.g., partially base) an access determination. For instance, the REX sensor 112 can be used to ensure that users are able to safely pass through the door 118. For instance, the REX sensor 112 can include a motion sensor configured to detect an approaching user. In some embodiments, the REX sensor 112 can include a push button (e.g., labeled “push to exit”). In some embodiments, the REX sensor 112 can include a sensor that determines whether an alarm (e.g., smoke alarm, fire alarm, etc.) is activated. The controller 104 can receive input(s) from the REX sensor 112 and can base an access determination partially on the input(s). For instance, the controller 104 may not allow access unless a motion sensor detects motion.

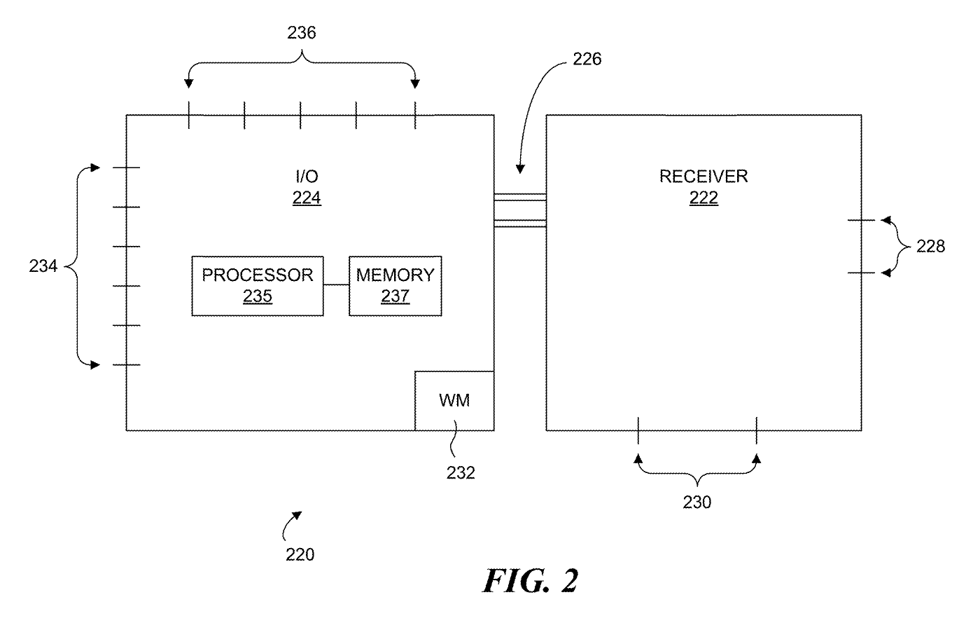

FIG. 2 illustrates a device 220 for access control in accordance with one or more embodiments of the present disclosure. As shown in FIG. 2, the device 220 can include a receiver 222 and an I/O component 224. The receiver 222 and the I/O component 224 can be physically (and electrically) attached via a plug attachment 226. In some embodiments, the receiver 222 includes a “male” portion of the plug attachment 226 and the I/O component 224 includes a “female” portion of the plug attachment 226. In some embodiments, the receiver 222 includes a “female” portion of the plug attachment 226 and the I/O component 224 includes a “male” portion of the plug attachment 226. The plug attachment 226 can removably attach the receiver 222 to the I/O component.

The receiver 222 can wirelessly communicate with a mobile device carried and/or worn by a user. For example, the mobile device can be a phone (e.g., smartphone), personal digital assistant (PDA), tablet, and/or wearable device (e.g., wristband, watch, necklace, etc.). The mobile device can include one or more software applications (e.g., apps) which can define and/or control communications between the mobile device and the receiver 222. In some embodiments, the mobile device can communicate using one or more communications modules (e.g., cellular, WiFi, etc.). Communication between various devices herein can be carried out over a wireless network. A wireless network, as used herein, can include WiFi, Bluetooth Low Energy (BLE) technology, or any other suitable means to wirelessly transmit and/or receive information.

In some embodiments, the device 220 can be located (e.g., installed) near a door and/or near a reader such that when a user approaches the door and/or the reader the user's mobile device can wirelessly communicate with the device 220 (e.g., the receiver 222 of the device 220). In some embodiments, the device 220 can be installed within a wall of the building.

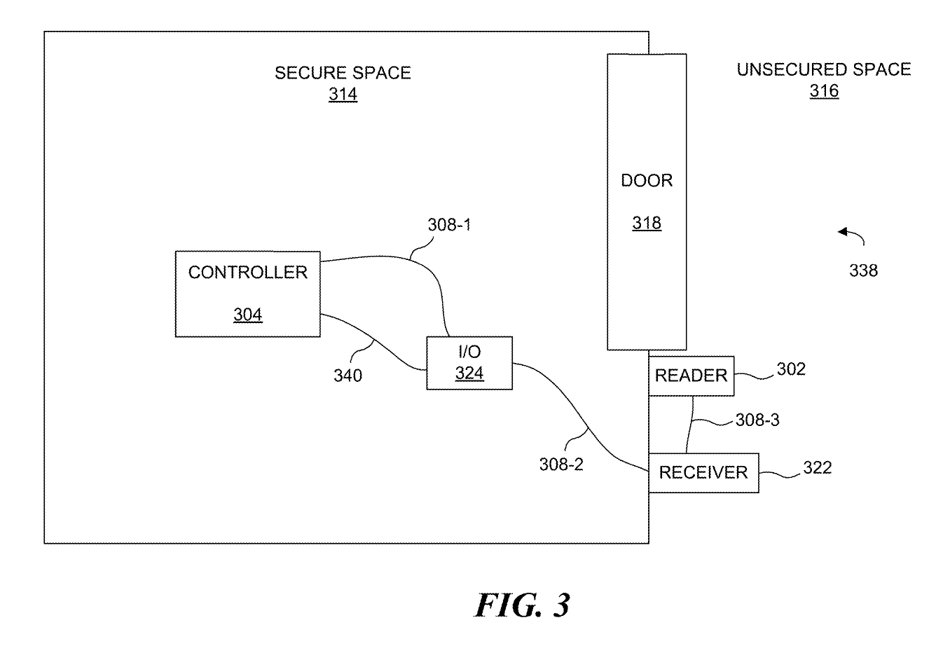

In some embodiments, such as the embodiment illustrated in FIG. 3, the receiver 222 and the I/O component 224 can be physically separated and connected via a wire. In such instances, the receiver can be located near the door and/or near the reader and the I/O component can be located in a different area (e.g., adjacent to a controller in a control closet).

The receiver 222 can include a number of input ports 228. The particular number of input ports 228 in accordance with embodiments of the present disclosure is not intended to be limited, that is the input ports 228 can include one or more input ports. The input ports 228 can allow the receiver to be connected (e.g., wired) to a reader, for instance. In some embodiments, the input ports 228 can be configured to accept a Wiegand wire.

The receiver 222 can include a number of output ports 230. The particular number of output ports 230 in accordance with embodiments of the present disclosure is not intended to be limited, that is the output ports 230 can include one or more output ports. The output ports 230 can allow the receiver 222 to be connected (e.g., wired) to the I/O component 224, for instance, in embodiments where the I/O component 224 and the receiver 222 are not physically attached via the plug attachment 226. In some embodiments, the input ports 228 can be configured to accept a Wiegand wire.

The I/O component 224 can be a device configured to send data to a controller and/or receive data from a controller. The I/O component 224 can include a wireless module (WM) 232. The wireless module 232 can allow a controller in communication with (e.g., connected to) the I/O module to have network connectivity (e.g., in an Ethernet, WiFi, Mesh, and/or Zigbee network).

Being connected to a network can allow the remote control of various network devices (e.g., sensors, relays, actuators, receivers, etc.)

remotely such that the building can be locked down, or a situation such as a “forced door” can be detected (e.g., a situation where a door is opened without a proper access determination having been made). Additionally, the controller, via a network connectivity enabled by the wireless module 232 can run complex access control logic and/or execute instructions (e.g., stored on a non-transitory computer-readable medium), which may be called for in situations where heightened security is desired.

The I/O component 224 can include a number of I/O ports 234. The particular number of I/O ports 234 in accordance with embodiments of the present disclosure is not intended to be limited, that is the I/O ports 234 can include one or more I/O ports. The I/O ports 234 can allow the I/O component to be connected (e.g., wired) to a controller, for instance.

The I/O component 224 can include a number of input ports 236 (e.g., Wiegand ports). The particular number of input ports 236 in accordance with embodiments of the present disclosure is not intended to be limited, that is the input ports 236 can include one or more input ports. The input ports 236 can allow the I/O component 224 to be connected (e.g., wired) to the receiver 222, for instance, in embodiments where the I/O component 224 and the receiver 222 are not physically attached via the plug attachment 226. In some embodiments, the input ports 228 can be configured to accept a Wiegand wire.

As shown in FIG. 3, the I/O component can include a memory 237 and a processor 235 coupled to the memory 237. The memory 237 can be any type of storage medium that can be accessed by the processor 235 to perform various examples of the present disclosure. For example, the memory 237 can be a non-transitory computer readable medium having computer readable instructions (e.g., computer program instructions) stored thereon that are executable by the processor 235 to control access to a secured space as described herein (e.g., in a manner analogous to a controller as described herein).

The memory 237 can be volatile or nonvolatile memory. The memory 237 can also be removable (e.g., portable) memory, or non-removable (e.g., internal) memory. For example, the memory 237 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

Further, although the memory 237 is illustrated as being located in the I/O module 224, embodiments of the present disclosure are not so limited. For example, the memory 237 can also be located internal to another computing resource (e.g., enabling computer readable instructions to be downloaded over the Internet or another wired or wireless connection).

FIG. 3 illustrates a system 338 for access control in accordance with one or more embodiments of the present disclosure. As shown in FIG. 3, the system 338 can be implemented to control access to a secure space 314 that is separated from an unsecured space 316 by a door 318.

A reader 302 can be located at or near the door 318 (e.g., within arm's reach of the door 318). In a manner analogous to the system 100 illustrated in FIG. 1, the system 338 includes a controller 304. The embodiment illustrated in FIG. 3 includes an existing access control system having a device (e.g., a device analogous to the device 220 illustrated in FIG. 2) installed therein.

In the embodiment illustrated in FIG. 3, an existing wire (e.g., a Wiegand wire) connecting the reader 302 with the controller 304 has been cut. For instance, one cut of the wire renders a wire portion 308-1 and a wire portion 308-2. Another cut of the wire renders a wire portion 308-3. The portion 308-1, the portion 308-2, and the portion 308-3 may be cumulatively referred to as “portions 308.”

An end of the portion 308-1 where the cut was made (e.g., an end opposing the controller 304) can be connected to an I/O port of an I/O component 324, which may be analogous to one or more of the I/O ports 234 of the I/O component 224 previously described in connection with FIG. 2. An end of the portion 308-2 where the cut was made (e.g., an end opposing the reader 302) can be connected to an input port of the I/O component 324, which may be analogous to one or more of the input ports 236 previously described in connection with FIG. 2.

Another end of the portion 308-2 (e.g., an end opposing the controller) can be connected to an output port of a receiver 322, which may be analogous to one or more of the output ports 230 of the receiver 222 previously described in connection with FIG. 2. An end of the portion 308-3 (e.g., an end opposing the reader 302) can be connected to an input port of the receiver 322, which may be analogous to one or more of the input ports 228 of the receiver 222 previously described in connection with FIG. 2.

In some embodiments, each of the portions 308 are formed from an existing wire connecting the reader 302 with the controller 304. That is, in some embodiments, the device (e.g., the receiver 322 and the I/O component 324) is configured to be installed in a building using existing wiring of the building such that the receiver 322 is connected to the reader 302 using an existing wire of the building, the I/O component 324 is connected to the controller 304 using the existing wire of the building.

In some embodiments, less than all of the portions 308 are formed from an existing wire connecting the reader 302 with the controller 304. That is, in some embodiments, at least one of the portions 308-1, 308-2, and 308-3 is not a cut portion of the existing wire. For example, the receiver 322 can be connected to the reader 302 using an existing wire of the building and the receiver 322 can be connected to the I/O component 324 using the existing wire of the building, but the I/O component 324 may be connected to the controller using a different (e.g., new and/or not-previously-installed wire).

The controller 304 can be connected to a power source (not illustrated so as not to obscure embodiments of the present disclosure). The connection formed using the portions 308 between the controller 304, the I/O component 324, the receiver 322, and the reader 302 can power the I/O component 324 and/or the receiver 322. That is, neither the I/O component 324 nor the receiver 322 requires an additional power source because the I/O component 324 and the receiver 322 can receive power from existing power sources via existing wiring.

Even with the I/O component 324 and the receiver 322 installed, the reader 302 can function normally (e.g., as it did before the installation of the I/O component 324 and the receiver 322). That is, the reader 302 can read a card presented thereto, and transmit a signal via the wire portions 308 to the controller 304, which can make an access determination.

Though not shown in FIG. 3 so as not to obscure embodiments of the present disclosure, the system 338 can include one or more sensors. For example, the system 338 can include a door position sensor and/or a REX sensor. The door position sensor can determine a position of the door 318 (e.g., open or closed). The position of the door 318 can be communicated via a wire (not shown) to an input port of the I/O component 324 and then to the controller 304 via a wire 340 connecting an I/O port of the I/O component 324 to the controller 304. Thus, the I/O component can act as an intermediary between the door position sensor and the controller 304. Similarly, the controller 304 can receive input(s) from the REX sensor with the I/O component acting as an intermediary.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A device for access control, comprising:
a wireless receiver component configured to be connected to an access reader; and
an input/output (I/O) component configured to be connected to the wireless receiver component and a controller, wherein the wireless receiver component is detachable from the I/O component.

2. The device of claim 1, wherein the wireless receiver component is a Bluetooth device.

3. The device of claim 1, wherein the device is configured to be installed in a building using existing wiring of the building such that:
the wireless receiver component is connected to the access reader using an existing wire of the building; and
the I/O component is connected to the controller using the existing wire of the building.

4. The device of claim 1, wherein the device is configured to be installed in a building using existing wiring of the building such that:
the wireless receiver component is connected to the access reader using an existing wire of the building; and
the wireless receiver component is connected to the I/O component using the existing wire of the building.

5. The device of claim 1, wherein the device is configured to be installed in a building using existing wiring of the building such that:
the wireless receiver component is connected to the access reader using an existing wire of the building;
the wireless receiver component is connected to the I/O component using the existing wire of the building; and
the I/O component is connected to the controller using the existing wire of the building.

6. The device of claim 1, wherein one of the wireless receiver component and the I/O component includes a plug, wherein the other of the wireless receiver component and the I/O component includes a plug receiver, and wherein the wireless receiver component is configured to be attached to the I/O component via a reception of the plug into the plug receiver.

7. The device of claim 1, wherein the I/O component includes a plurality of Wiegand ports.

8. The device of claim 1, wherein the I/O component includes a plurality of I/O ports.

9. A system for access control, comprising:
a wireless receiver component connected to an access reader via a first portion of an existing wire of a building, wherein the wireless receiver component is configured to receive a request to access a secured area of the building from a mobile device associated with a user;
an input/output (I/O) component connected to the wireless receiver component via a second portion of the existing wire of the building and configured to receive the request from the wireless receiver component; and
a controller connected to the I/O component and configured to receive the request from the I/O component and determine whether the user is allowed access to the secure area.

10. The system of claim 9, wherein the controller is connected to the I/O component via a third portion of the existing wire of the building.

11. The system of claim 9, wherein the first portion and the second portion of the existing wire of the building are formed by cutting the existing wire of the building.

12. The system of claim 9, wherein the system includes a request to exit sensor connected to the I/O component.

13. The system of claim 9, wherein the system includes a door position sensor connected to the I/O component.

14. The system of claim 9, wherein the wireless receiver component is located in a first area of the building and wherein the I/O component and the controller are located in a second area of the building.

15. A system for access control, comprising:
a device, including:
a wireless receiver component connected to an access reader of a building via an existing wire of a building, wherein the wireless receiver component is configured to receive a request to access a secured area of the building from a mobile device associated with a user; and
an input/output (I/O) component physically attached to the wireless receiver component, wherein the I/O component is configured to receive the request from the wireless receiver component;
a controller connected to the I/O component of the device via the existing wire of the building, wherein the controller is configured to determine whether the user is allowed access to the secured area based on the request.

16. The system of claim 15, wherein the device is located in a first area of the building and wherein the controller is located in a second area of the building.

17. The system of claim 15, wherein the system includes a relay configured to allow the user access to the secured area responsive to a determination by the controller that the user is allowed access.

18. The system of claim 15, wherein the device receives power from an existing power source connected to the controller.

19. The system of claim 15, wherein the access reader is configured to read an access card associated with the user and transmi a signal to the controller, and wherein the controller is configured to determine whether the user is allowed access to the secured area based on the signal.

20. The system of claim 15, wherein the existing wire of the building is a Wiegand wire having five cores.
